(19) United States
(12) Patent Application Publication
(10) Pub. No.: US 2010/0133193 A1
(43) Pub. Date: Jun. 3, 2010

(54) DIESEL SULFUR FILTER-NANOADSORBER AND METHOD OF FILTERING A LIQUID FUEL

(75) Inventors: Gary B. Zulauf, Findlay, OH (US); Ronald P. Rohrbach, Flemington, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/650,061

(22) Filed: Dec. 30, 2009

Related U.S. Application Data
(63) Continuation-in-part of application No. 11/674,913, filed on Feb. 14, 2007, now Pat. No. 7,575,688.
(60) Provisional application No. 61/142,012, filed on Dec. 31, 2008.

(51) Int. Cl. B01D 15/08; B01D 35/02; B01D 39/20

(52) U.S. Cl. 210/660; 210/502.1

(57) ABSTRACT

Disclosed herein is filter media that may be used for removing sulfur-containing compounds from a post-refinery fuel stream. The filter media comprises an inorganic oxide nanomaterial having a surface acidity characterized by a pKₐ value of less than or equal to −3. Also disclosed is a method of filtering a liquid fuel using the filter media.

### CROSS REFERENCE TO RELATED APPLICATIONS

This patent application claims the benefit of U.S. Provisional Patent Application No. 61/142,012 filed on Dec. 31, 2008, which is incorporated herein by reference in its entirety. This patent application is a continuation-in-part of U.S. patent application Ser. No. 11/674,913, filed Feb. 14, 2007, now U.S. Pat. No. 7,575,688, which is incorporated herein by reference in its entirety.

### STATEMENT REGARDING FEDERALLY SPONSORED RESEARCH & DEVELOPMENT

Embodiments of this invention may have been made with governmental support under Contract No. DE-FC26-02NT41219. Therefore, the U.S. Government may have a paid-up license to portions or embodiments of this invention and the right in limited circumstances to require the patent owner to license to others on reasonable terms as provided for by the terms of Contract No. DE-FC26-02NT41219.

### BACKGROUND

There continues to be environmental concern relating to air pollution stemming from use of internal combustion engines, especially those used in transportation applications such as cars, trucks, boats and the like, and stationary power sources such as diesel generators and the like. In addition to being a direct source of pollution in the form of SOₓ, sulfur also poisons the catalytic surface of exhaust after treatment devices. By reducing sulfur in the fuel and therefore the exhaust, the useful life of exhaust after treatment devices is extended.

New power sources such as hydrocarbon fuel cells will also require fuel streams to have similar or lower levels of sulfur. Fuel cells burn hydrogen that has been reformed from various hydrocarbon fuels, such as gasoline. Sulfur will poison the active surfaces of the fuel cell, thus shortening its life.

As a result, various governments and regulatory bodies continue to enact legislation intended to substantially lower the acceptable levels of sulfur and sulfur-containing compounds present in the fuels used in internal combustion engines.

The U.S. EPA, for instance, has enacted regulations requiring diesel fuel producers to phase in the production of low sulfur diesel fuel (equal to or less than 15 ppm sulfur) beginning in 2006 and ending in 2010. Similarly, from 2004 to 2006, gasoline sulfur levels were reduced from 50 ppm to 30 ppm.

The need for commercially available fuels having continually lower levels of sulfur-containing compounds creates new problems for the manufacturers, of such fuels, i.e., the refining industry as well as the distributors and direct sellers of commercial fuels. In some cases, the refining industry may be unable to provide post-refinery fuels having levels of sulfur-containing compounds in accordance with recently enacted legislation. In other cases, a refinery may have produced fuel that was initially at an acceptable level but which subsequently became contaminated at some point enroute to the distributor and/or direct seller. In all such cases, the commercially available fuel feedstock may require addition removal of sulfur-containing compounds.

The refining industry has used several different approaches for removing sulfur from commercially available fuel feedstocks such as gasoline and diesel.

The most common methods employed by the refinery industry for the removal of sulfur from fuels are hydrodesulfurization (HDS), Merox thiol extraction processing, and adsorption.

However, such processes continue to be unable to produce cost effective commercially available fuels that have acceptable levels of sulfur-containing compounds.

Moreover, in many cases, the remaining sulfur-containing compounds present in commercially available fuels are especially difficult to remove, i.e., mono-alkyl-substituted dibenzothiophenes and, in particular, poly-alkyl-substituted dibenzothiophenes.

As a result, it is now recognized that there is a need for the development of processes and apparatus capable of removing sulfur-containing compounds from fuel feedstocks that have already been subjected to sulfur removing processes by the manufacturer of the fuel feedstock, i.e., a refinery, and will hereafter be referred to as “post-refinery” fuels or “feedstocks”. These processes and apparatus employed with regards to post-refinery fuels may be referred to as “sulfur polishing” processes and/or apparatus.

Since post-refinery fuel feedstocks have reduced levels of sulfur-containing compounds, such sulfur polishing technology must be capable of producing fuels having particularly low concentrations of sulfur-containing fuels, i.e., less than 50 ppm and more particularly less than 15 ppm.

In addition, sulfur-polishing technology must be applicable for use in a wide variety of environments without the use of heavy, large, complex and/or expensive processing equipment, components, pretreatment processes, chemicals, high temperatures and pressures and the like. Ideally, pressures and temperatures would not exceed those normally experienced in an internal combustion engine (ICE) fuel system.

For example, it would be advantageous if sulfur-polishing technology were suitable for use in the normal fuel distribution systems employed by refineries to distribute their manufactured product. The components of such fuel distribution systems may be generally referred to as interim storage devices, i.e., above and below ground storage tanks, tanker trucks, filter trucks, connecting piping, metering and dispensing equipment, and the like. It would be desirable to provide sulfur-polishing technology that could be easily and economically utilized by any entity at any point in a fuel distribution system, i.e., refineries, blenders, distributors, processors, direct sellers of fuel and the like.

It would also be especially advantageous if an end user or consumer of a commercially available fuel could readily and easily employ a sulfur polishing technology as a sulfur filter in a vehicle, stationary engine or other point of use application.

For example, there remains a need for devices, especially fuel filters, which could reduce the amount of sulfur-containing compounds in a commercially available fuel stream to a desirable concentration, especially to concentrations of 3 ppm or less. More particularly, there remains a need for such sulfur reducing fuel filters which are economical and capable of consumer-friendly installation and removal with respect to mobile vehicles such as automobiles, trucks, boats, and the like, that utilize internal combustion engines or fuel cells as a power source and for stationary engine applications. Such applications are herein after referred to as on-board vehicle desulfurization or sulfur-polishing processes or fuel filters.

It would be especially advantageous to provide on-board vehicle sulfur-polishing fuel filters that rely on simple adsorptive sulfur uptake mechanisms that do not require pretreatment of fuel streams directly introduced by a vehicle operator.

Further, it would be desirable to provide an on-board vehicle desulfurization fuel filter that relies on simple adsorptive sulfur uptake mechanisms but which does not require an adsorbent comprising expensive metal catalyst. Those of skill in the art will appreciate that adsorptive sulfur uptake mechanisms and processes may be distinguished from traditional hydrodesulfurization processes. The term “hydrodesulfurization” refers to processes that comprise adding hydrogen to a fuel gas, decomposing and converting a sulfur compound into hydrogen sulfide in the presence of a catalyst such as a Co—Mo catalyst, and desulfurizing by adsorption of hydrogen sulfide, which is a decomposition product, by means of a desulfurizing agent such as zinc oxide, iron oxide or the like. Although the hydrodesulfurization process is a reliable process, it is necessary to convert all sulfur compounds into hydrogen sulfide by hydrogenation and heating to about 300 to 400° C. In addition, since zinc oxide or iron oxide is used for adsorption and removal, operations become complicated. Accordingly, this process has been employed in a large-scale plant, but is difficult to apply to a small-sized apparatus, especially to on-board vehicle desulfurization fuel filters. In contrast, a process of removing a sulfur compound at normal temperatures by use of an adsorbent needs neither heat or hydrogen as in a hydrodesulfurization process or a thermal adsorption process, and thus, is a simple desulfurization process. It will be appreciated that hydrodesulfurization processes are unsuitable for use as sulfur-polishing processes, especially with respect to on board sulfur-polishing processes.

As a result, the prior art has failed to satisfy the need for methods and apparatus for removing sulfur-containing compounds from post-refinery fuels. Although the prior art has attempted to provide devices that remove sulfur-containing fuels from petroleum based streams it has been unable to provide commercially acceptable sulfur-polishing technologies.

For example, U.S. Pat. No. 5,454,933 discloses the treatment of a hydrodesulfurized fuel with a solid adsorbent material. Examples of such solid adsorbents include silica gel, activated alumina, zeolites, supported CoMo sorbents, activated coke, and activated carbon.

U.S. Pat. No. 6,533,924 discloses a fuel processing method for the removal of sulfur present in an undiluted oxygenated hydrocarbon fuel which contains an oxygenate and is used to power an internal combustion engine in a mobile environment, such as an automobile or the like, or in a stationary environment.

U.S. Patent Application Publication No. U.S. 2001/0035006 A1 discloses an exhaust gas catalyst comprising: a sulfur trap warm-up catalyst, housed within the exhaust stream and comprising a sulfur scavenger component; and a NOx adsorber catalyst housed within the exhaust stream downstream from said sulfur trap in an underfloor position. The sulfur scavenging component comprises metallic trapping elements including silver, aluminum, barium, cerium, cobalt, copper, zinc, and the like that may be applied to supporting materials such as high surface area materials such as alumina, (including gamma alumina, alpha alumina, theta alumina, and the like) zeolite, zirconia, silica, and the like.

U.S. Patent Application Publication No. U.S. 2002/0028505 A1, the contents of which are incorporated herein by reference thereto, discloses a desulphurization apparatus to be mounted in automobiles, which is arranged between a fuel tank and an injector of an engine, the apparatus comprising a combination of a sulfur-containing compound adsorbent for adsorbing and concentrating the sulfur-containing compound and a sulfur-containing compound oxidizing agent or oxidation catalyst for oxidizing the adsorbed sulfur-containing compound, the apparatus further comprising a means for recovering and removing the resulting sulfur-containing oxide.

Therefore, there remains a need for filter media that can be employed for sulfur-polishing, and that is particularly suited for use in sulfur-polishing technologies employed for post-refinery fuel treatment, particularly end use applications, such as on-board vehicle treatment systems, fuel cell treatment systems and various industrial engine applications.

### SUMMARY

Disclosed are filter media that may be used for removing sulfur-containing compounds from a post-refinery fuel stream. The filter media disclosed are particularly suited for various end use applications, including on-board vehicle applications, fuel cells and various industrial engine applications.

In one embodiment, a filter medium for removing a sulfur-containing compound from a liquid fuel comprises an inorganic oxide nanomaterial having a surface acidity characterized by a pKa value of less than or equal to −3.

In another embodiment, a method of making a filter medium comprising an inorganic oxide nanomaterial configured to remove a sulfur-containing compound from a liquid fuel comprises providing a substrate that is configured to receive an inorganic oxide nanomaterial and disposing the inorganic oxide nanomaterial on the substrate wherein the inorganic oxide nanomaterial having a surface acidity characterized by a pKa of less than or equal to −3.

In another embodiment a method of filtering a liquid fuel comprises contacting a liquid fuel with a filter medium comprising an inorganic oxide nanomaterial having a surface acidity characterized by a pKa value of less than or equal to −3.

### DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings wherein like elements are numbered alike in the several figures:

FIG. 1 is a perspective view of an exemplary embodiment of a filter medium as disclosed herein;

FIG. 2 is a cross-sectional view of an exemplary embodiment of a fuel filter and filter medium as disclosed herein;

FIG. 3 is a cross-sectional view taken along Section 3-3 of FIG. 1;

FIG. 4 is a cross-sectional view of a second exemplary embodiment of a filter medium as disclosed herein;

FIG. 5 illustrates an exemplary embodiment of an inorganic oxide nanomaterial morphology as disclosed herein;

FIG. 6 illustrates a second exemplary embodiment of an inorganic oxide nanomaterial morphology as disclosed herein;

FIG. 7 is a cross-sectional view of a second exemplary embodiment of a fuel filter and filter medium as disclosed herein;

FIG. 8 is a cross-sectional view of a third exemplary embodiment of a fuel filter and filter medium as disclosed herein;

FIG. 9 is a schematic illustration of one embodiment of the disclosed fuel filter comprising a single column;

FIG. 10 is another embodiment of the disclosed fuel filter comprising a single column with a guard bed;

FIG. 11 is an alternative embodiment of the disclosed fuel filter of FIG. 2 comprising a single column with a guard belt;

FIG. 12 is a schematic illustration of another embodiment of the disclosed fuel filter comprising a single column with dual guard beds;

FIG. 13 is a schematic illustration of yet another embodiment of the disclosed fuel filter comprising dual columns with a single guard bed;

FIG. 14 is a schematic illustration of another embodiment of the disclosed fuel filter comprising dual columns with dual guard beds;

FIG. 15 is an alternative embodiment of the disclosed embodiment of the disclosed fuel filter of FIG. 14 comprising dual columns with dual guard beds;

FIG. 16 illustrates the correlation between surface acidity as measured by the visual color change method and sulfur removal capacity;

FIG. 17 illustrates the effect of varying surface acidity upon the sulfur removal capacity of a single refractory inorganic oxide; and

FIG. 18 is a schematic illustration of an internal combustion engine and NOx adsorber with a disclosed fuel filter.

### DETAILED DESCRIPTION

Disclosed are filter media, fuel filters and methods that are capable of removing sulfur-containing compounds from a post-refinery fuel stream.

The term “post-refinery fuel stream” or “post-refinery fuel” as used herein broadly refers to a fuel or fuel stream (used interchangeably herein) that is manufactured by a petroleum refinery. In one exemplary embodiment, post-refinery fuel refers to a fuel manufactured by a petroleum refinery employing at least one sulfur removing technology. In one embodiment, a post-refinery fuel stream will comprise sulfur-containing compound(s) in a concentration of no more than 2000 ppm. In another embodiment, a post-refinery fuel stream will comprise sulfur-containing compound(s) in a concentration of no more than 100 ppm. In one exemplary embodiment, a post-refinery fuel stream will comprise sulfur-containing compound(s) in a concentration of no more than 15 ppm. In one embodiment, a post-refinery fuel stream contains a population of sulfur species present as various substituted alkyl, benzo, and dibenzothiophenes.

As used herein “fuel filter” is intended to describe a fuel filter designed to remove sulfur-containing compounds found in fuels. As used herein, “filter medium” or “filter media” is intended to describe one or more filter medium, respectively, designed for use in a fuel filter to remove sulfur-containing compounds found in fuels. It is understood that in accordance with exemplary embodiments a separate fuel filter may be provided to remove additional contaminants from the fuel (e.g., a typical non-sulfur removing fuel filter). Alternatively, a single fuel filter configured for both removal and release of sulfur-containing compounds and filtering of other contaminants is contemplated to be within the scope of alternative embodiments of the disclosed fuel filters and methods of using the same.

The disclosed filter media, fuel filters and methods can be used with power sources such as internal combustion engines and fuel cells employed in both stationary systems and motor vehicles. Alternatively, the disclosed filter media, fuel filters and methods can be used at any point or location in traditional fuel distribution systems that distribute post-refinery fuel streams to remove sulfur-containing compounds that may be undesirably present in a post-refinery fuel.

Illustrative examples of internal combustion engines include gasoline powered engines and diesel engines.

The disclosed filter media, fuel filters and methods are also generally suitable for use with hydrocarbon fuel cells having an anode, a cathode, and an electrolyte in between the two electrodes wherein typically an oxidation reaction (e.g., H2→2H+ +2e) takes place at the anode and a reduction reaction (e.g., O2+2H2O+4e→4OH−) takes place at the cathode.

Illustrative examples of hydrocarbon fuel cells include Proton Exchange Membrane or Polymer Electrolyte Membrane (PEM) fuel cells, phosphoric acid (PA) fuel cells, molten carbonate (MC) fuel cells, solid oxide (SO) fuel cells, and alkaline fuel cells.

Illustrative examples of stationary systems include generators and power plants.

Illustrative examples of motor vehicles include cars, trucks, boats, personal water craft, semi-trucks, construction devices such as bulldozers and cranes, small engine devices such as lawn mowers and tractors, and the like.

In one embodiment, the filter medium and fuel filter for removing or reducing the concentration of sulfur-containing compounds will be installed on such motor vehicles such that any fuels introduced into the vehicle must pass through the fuel filter before entering the internal combustion engine. In such applications, the fuel filter for removing sulfur-containing compounds, i.e., a sulfur reducing or removing fuel filter may be referred to as an on-board vehicle sulfur-polishing or desulfurization component or process.

In one exemplary embodiment, the sulfur removing filter medium and fuel filter will be used as an on-board vehicle desulfurization component that is part of an emission control system wherein the filter releases captured sulfur-containing compounds into the fuel stream during a regeneration process of a NOx adsorber, wherein the regeneration of the NOx adsorber is conducted in accordance with technologies known to those skilled in the related arts.

In addition, the disclosed filter media and fuel filters and methods can be used at any point or location in traditional fuel distribution systems that distribute post-refinery fuel streams to remove sulfur-containing compounds that may be undesirably present in a post-refinery fuel.

Such fuel distribution systems may be characterized by (i) a refinery that manufactures the post-refinery fuel stream and (ii) one or more interim storage devices. In another embodiment, a fuel distribution system may also include (iii) one or more fuel consuming articles or vehicles having a power source for which consumers introduce fuel. Illustrative examples of interim storage devices include underground and above ground storage tanks, tanker trucks, fuel discharge or dispensing devices, connecting piping, and the like. Fuel consuming articles or vehicles having a power source that consumes fuel include the descriptions above for motor vehicles and stationary systems.

Illustrative post-refinery fuel streams include gasoline, kerosene, heating oil, jet fuel, cracked-gasoline, blends containing “gas to liquid fuels” derived from natural gas, blends containing “coal to liquid fuels” derived from coal, biofuels such as ethanol, blends contains biofuels, or diesel fuel. In one exemplary embodiment, the fuel will be diesel fuel.

The term “gasoline” denotes a mixture of hydrocarbons boiling in the range of from about 100° F. to about 400° F., or any fraction thereof. Examples of suitable gasoline include, but are not limited to, hydrocarbon streams in refineries such as naphtha, straight-run naphtha, coker naphtha, catalytic gasoline, naphtha, alkylate, isomerate, reformate, and the like and combinations thereof.

The term “cracked-gasoline” denotes a mixture of hydrocarbons boiling in the range of from about 100° F. to about 400° F., or any fraction thereof, that are products from either thermal or catalytic processes that crack larger hydrocarbon molecules into smaller molecules. Examples of suitable thermal processes include, but are not limited to, coking, thermal cracking, visbreaking, and the like and combinations thereof. Examples of suitable catalytic cracking processes include, but are not limited to, fluid catalytic cracking, heavy oil cracking, and the like and combinations thereof. Thus, examples of suitable cracked-gasoline include, but are not limited to, coker gasoline, thermally cracked gasoline, fluid catalytically cracked gasoline, heavy oil cracked gasoline, and the like and combinations thereof.

The term “diesel fuel” denotes a mixture of hydrocarbons boiling in the range of from about 300° F. to about 750° F., or any fraction thereof. Examples of suitable diesel fuels include, but are not limited to, light cycle oil, kerosene, jet fuel, straight-run diesel, hydrotreated diesel, and the like and combinations thereof.

The sulfur-containing compounds removed by the disclosed fuel filter may in general be any sulfur-containing compound normally found in fuels intended for use in internal combustion engines. The disclosed fuel filters may remove one or more of such compounds from a fuel stream.

The term “sulfur” or “sulfur-containing compound” denotes sulfur in any form such as elemental sulfur or a sulfur compound normally present in a hydrocarbon-containing fluid such as cracked gasoline or diesel fuel. Examples of sulfur which can be present during a disclosed process, include, but are not limited to, hydrogen sulfide, carbonyl sulfide (COS), carbon disulfide (CS2), mercaptans (RSH), organic sulfides (R—S—R), organic disulfides (R—S—S—R), thiophene, substituted thiophenes, organic trisulfides, organic tetrasulfides, benzothiophene, alkyl thiophenes, alkylated benzothiophenes, dibenzothiophenes, alkylated dibenzothiophenes, and the like and combinations thereof as well as the heavier molecular weights of same which can be present in a diesel fuel, wherein each R can be an alkyl or cycloalkyl or aryl group containing one carbon atom to ten carbon atoms.

In one exemplary embodiment, the sulfur-containing compounds removed by the disclosed filter media, fuel filters or processes will be sulfur-containing aromatic compounds. In one embodiment, the sulfur-containing compounds removed by the disclosed fuel filter medium include benzothiophene, dibenzothiophene, and derivatives thereof.

In one embodiment, the disclosed fuel filter media, fuel filters and methods can be used with the interim storage devices of a traditional fuel distribution system. It will be appreciated that such methods and fuel filters and associated filter media may be employed at numerous locations within such interim storage devices. For example, a fuel desulfurization filter could be incorporated into the dispensing device at the point of use or at the entrance or exit of an interim storage device. In another embodiment, a fuel desulfurization filter and associated filter medium could be incorporated at one or more central distribution points.

In yet another embodiment, the disclosed filter media, fuel filters and methods may be used to bring post-refinery fuels back into compliance. That is, post-refinery fuels can become contaminated at any point along the post-refinery fuel distribution chain and a once compliant post-refinery fuel may thereafter possess levels of sulfur-containing compounds outside legally allowed limits. For example, the disclosed filter media, fuel filters and methods could be employed in mobile filter trucks that could be used where needed to ensure that a post-refinery fuel possesses acceptable levels of sulfur-containing compounds.

The disclosed fuel filters and associated filter media are also suitable for use with commercially available post-refinery fuels directly inserted into motor vehicles by a vehicle operator through a fuel intake opening in the vehicle. In one exemplary embodiment, the post-refinery fuels will be unadulterated, that is, they will not be subject to any pretreatment steps prior to passing through the disclosed fuel filters and associated filter media except for those employed by the original manufacturing refinery. Such fuels may be referred to as unadulterated post-refinery fuels.

Fuels or fuel streams that pass through the disclosed fuel filters and associated filter media and methods in any of the foregoing embodiments may be referred to as “clean fuels” or “polished fuels”.

In one embodiment, an unfiltered or “contaminated” post-refinery fuel streams may comprise sulfur concentrations of about 6 ppm to about 500 ppm. In another embodiment, the disclosed filter media, filters and methods may be used with post-refinery fuel streams having sulfur concentrations of about 15 ppm or less. In one exemplary embodiment, the disclosed filter media, filters and methods may be used with post-refinery fuel streams having sulfur concentrations of about 9 ppm or less. In one embodiment, the disclosed filter media, filters and methods may be used with refinery fuel streams having sulfur concentrations of about 6 ppm to about 15 ppm. As used herein, fuel passing through the filter media or fuel filters described herein may be described as contaminated as it passes through the filter. This simply reflects that the fuel may be continuously filtered as it passes through or along the length of a given filter medium and filter.

In one embodiment, the disclosed method will result in filtered or clean fuel streams having a reduced concentration of sulfur or sulfur-containing compounds as compared to the unfiltered or contaminated post-refinery fuel. In another embodiment, the disclosed method will result in filtered or clean fuel streams having reduced concentrations of sulfur or sulfur-containing compounds of 15 ppm or less. In another embodiment, the disclosed method will result in filtered or clean fuel streams having reduced concentrations of sulfur or sulfur-containing compounds of 3 ppm or less.

The disclosed filter media and fuel filters that they comprise an adsorbent comprising an inorganic oxide nanomaterial having a surface acidity characterized by a pKa less than or equal to −3. In one embodiment, the disclosed fuel filters and filter media comprise an adsorbent consisting essentially of an inorganic oxide having a surface acidity characterized by a pKa less than or equal to −3. “Consisting essentially of” when used to describe the adsorbent is defined as having less than or equal to 5 weight percent (wt %), or, more specifically, less than or equal to 3 wt %, or, even more specifically, less than or equal to 1 wt % of an inorganic oxides having a pKa greater than −3.

The term “inorganic oxide nanomaterial” as used herein refers to high surface area materials wherein the high surface area includes and is at least partly attributable to nanometer-scale features. The nanomaterial can be particulate, dendritic, fibrous, porous, or a combination of any of the foregoing forms. The nanomaterial may comprise other high surface area morphological forms that incorporate nanometer-scale features. The nanomaterials are configured to adsorb sulfur-containing aromatic compounds. The nanometer-scale features will have an average size of one or more major dimensions that is less than about 500 nanometers (nm), or, more particularly, a major dimension which is less than or equal to about 150 nm, or, even more particularly, a major dimension that is less than or equal to about 40 nm. As used herein, “major dimension” refers to one of the dimensions used to assess the shape factor of the shape feature with which it is associated. By means of non-limiting example, for particles that are spherical or generally uniformly distributed above a centroid, the major dimension would be the diameter or uniform spacing about the centroid, respectively. For non-spherical nanoparticle shapes a major dimension would include a dimension that defines the shape factor of the particle, such as major and minor diameters in the case of substantially ellipsoidal particle shapes, or dimensions that define a length, width or thickness of the particle in the case of other non-spherical shapes. As a further non-limiting example, in the case of generally cylindrical nanodendrites, the average length and diameter or width of the dendrites. In yet another non-limiting example, in the case of fibrous nanomaterials, the average length and diameter or width of the nano-scale fibers. In yet another non-limiting example, in the case of porous nanomaterials, the dimensions which define the shape factor of the pore, such as a diameter or other dimension that characterizes the opening of the pore, as well as the length, depth or other dimension that defines the shape factor of the pore. In one embodiment, suitable inorganic oxides have pores having an average diameter of 1 to 40 angstroms. Within this range the average pore diameter can be greater than or equal to 5 angstroms, or, more specifically, greater than or equal to 10 angstroms.

The inorganic oxide nanomaterials disclosed herein have a surface area of at least 50 meters squared per gram or more. The surface area of the inorganic oxide nanomaterials can be about 50 to about 5000 meters squared per gram. More particularly, the surface area of the inorganic oxide nanomaterial can be about 50 to about 1500 meters squared per gram. Even more particularly, the surface area of the inorganic oxide nanomaterial can be about 150 to about 500 meters squared per gram.

Illustrative examples of suitable inorganic oxide nanomaterials include alumina, alumina-boria, alumina phosphate, activated alumina, hafnia, kaolinite (either sodium, ammonium or hydrogen forms), magnesia, montmorillonite (either sodium, ammonium or hydrogen forms), aluminosilicates, silica gels, clay, active clay, silica, silica-magnesia, mesoporous silica porous material (FSM), silica-alumina, solid super acids, solid super acids-sulfated, titanates, titania, zeolites, zirconia, sulfated zironia, or a combination thereof. In one exemplary embodiment, suitable inorganic oxides will be at least one of alumina, zeolite, silica-alumina, silica, alumina phosphate, solid super acids, silica gels, titanates, zironia, titania, hafnia, or a combination thereof.

In one especially exemplary embodiment, the inorganic oxide will be alumina. The term “alumina” as used herein refers to Al2O3.

Although many types and phases of alumina are suitable for use in the disclosed filter media, fuel filters and methods, in one embodiment, the inorganic oxide comprises gamma alumina, eta alumina, or mixtures thereof.

However, notwithstanding the foregoing, only those inorganic oxides having a surface acidity characterized by a pKa less than or equal to −3 are suitable for use in the disclosed filter media, fuel filters and methods.

It will be appreciated that the term “surface acidity” as used herein refers to a surface that has an acidity measurable by visual color change via an acid base indicator such as dicinnamalacetone.

In one embodiment, the disclosed fuel filters will comprise an adsorbent comprising, consisting essentially of, or consisting of, an inorganic oxide nanomaterial having a surface acidity characterized by a pKa less than or equal to −3. In one embodiment, the disclosed filter media and fuel filters will comprise an adsorbent comprising, consisting essentially of, or consisting of, an inorganic oxide nanomaterial having a surface acidity characterized by a pKa less than or equal to −6. In another embodiment, the disclosed fuel filters will comprise an adsorbent comprising, consisting essentially of, or consisting of, an inorganic oxide having a surface acidity characterized by a pKa less than or equal to −8. In another embodiment, the disclosed filter media and fuel filters will comprise an adsorbent comprising, consisting essentially of, or consisting of an inorganic oxide having a surface acidity characterized by a pKa of about −3 to about −8. It will be appreciated the function of the adsorbent is the adsorption and removal of sulfur-containing compounds from a fuel stream.

Suitable inorganic oxides nanomaterials may be obtained by the calcination of an otherwise suitable inorganic oxide nanomaterial. In one embodiment, otherwise suitable inorganic oxide nanomaterials will those be inorganic oxides which lack the requisite surface acidity but which are otherwise as described above. In one exemplary embodiment, suitable inorganic oxide nanomaterials will be obtained by the calcination of inorganic oxide nanomaterials which lack the requisite surface acidity but which are otherwise as described above and which are commercially available.

In one embodiment, suitable inorganic oxides nanomaterials will be obtained by heating a commercially available and otherwise suitable inorganic oxide nanomaterial to a temperature of at least 400° C. for a time sufficient to obtain a surface acidity characterized by a pKa less than −3. Heating is usually performed in a substantially dry environment such as under a flow of nitrogen or argon. In another embodiment, suitable inorganic oxide nanomaterial will be obtained by heating an otherwise suitable and commercially available inorganic oxide nanomaterial to a temperature of 400 to 800° C. under a flow of nitrogen or argon for a time sufficient to obtain a surface acidity characterized by a pKa less than −3, typically about 1 to about 16 hours. In one exemplary embodiment, suitable inorganic oxide nanomaterial will be obtained by heating an otherwise suitable and commercially available inorganic oxide nanomaterial to a temperature of 400 to 450° C. under a flow of nitrogen for about 1 to about 16 hours. After preparation, the adsorbent may be stored under dry nitrogen until use.

It will be appreciated that the disclosed absorbents may in one embodiment comprise metals and metal oxides such as Group VIIIA metals, Group IVA, Group IVB and the like.

However, in one embodiment, the disclosed adsorbents may optionally be untreated with any metals or metal oxides other than those discussed above in the context of inorganic oxides. That is, in one embodiment, the disclosed adsorbents will consist essentially of the inorganic oxide nanomaterial having a surface acidity characterized by a pKa of less than or equal to −3. In another exemplary embodiment, the disclosed adsorbents will consist essentially of an inorganic oxide nanomaterial having a surface acidity characterized by a pKa of less than or equal to −3 and that is substantially free of the metals and metal oxides traditionally employed as desulfurization catalysts or absorbents. “Substantially free’ in this context allows for the presence of trace amounts (contaminants) in amounts less than 100 parts by weight per million parts by weight of inorganic oxide nanomaterial (ppm). In another exemplary embodiment, the disclosed adsorbents will consist essentially of an inorganic oxide nanomaterial having a surface acidity characterized by a pKa of less than or equal to −3 and that is substantially free of the metals and metal oxides such as Group VIIIA metals, Group IVA, Group IVB and the like.

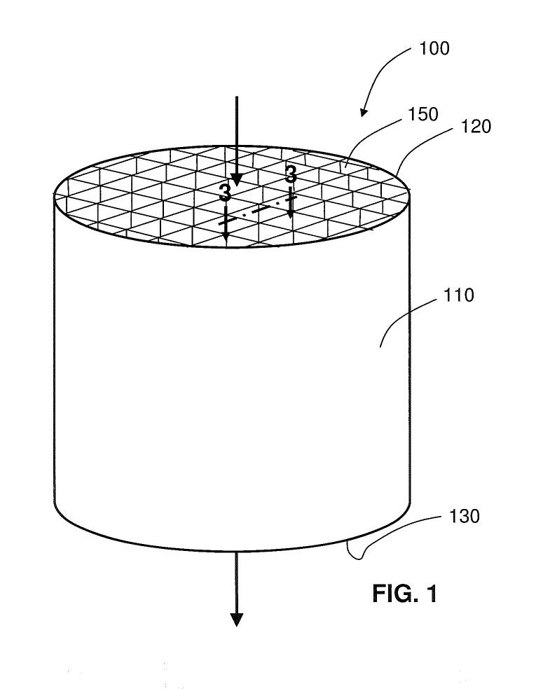

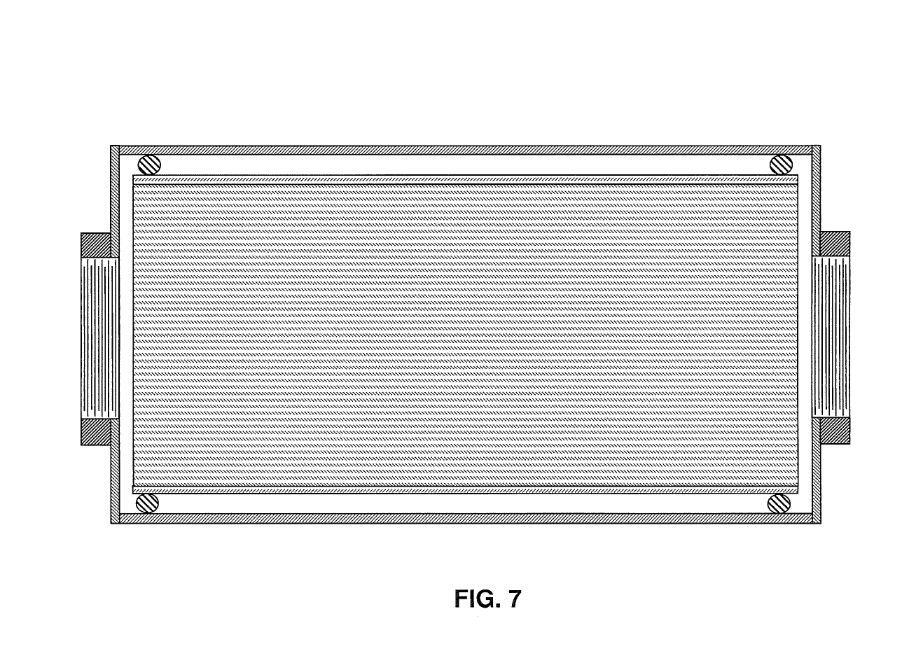

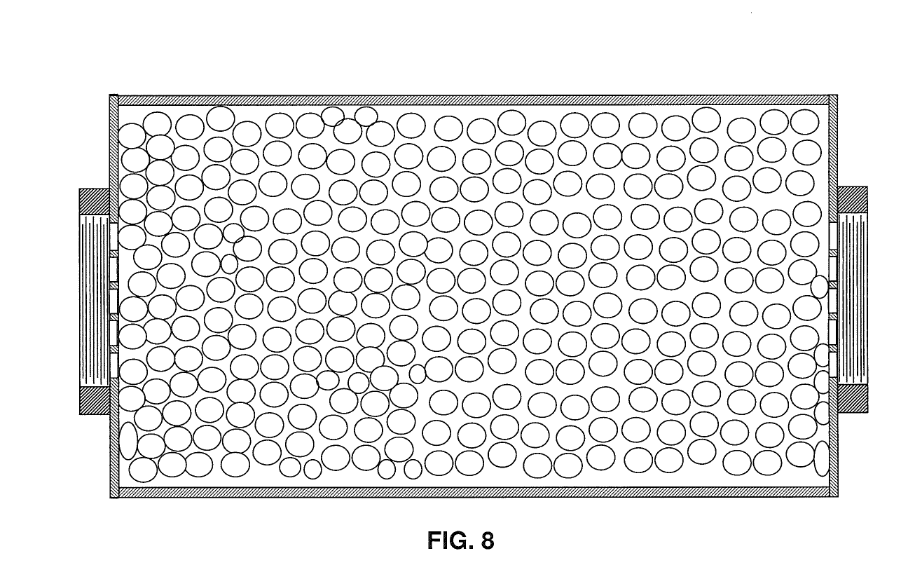

Referring to FIGS. 1-15, the nanomaterials described herein may be employed in any suitable form or manner that is effective for filtration of sulfur-containing compounds from a liquid fuel. This includes use of the nanomaterials themselves, without the incorporation of any additional supporting structure. This would include all forms of the nanomaterials which are not associated with a substrate or other supporting structure, but where the nanomaterials themselves comprise the filter medium. In an exemplary embodiment, this would include use of particulate, dendritic, fibrous or porous nanomaterials, or the like, or a combination thereof, as the filter medium, such as a bed of these nanomaterial forms. In another exemplary embodiment, this would include a bed, web, mat, felt, cloth or other form of dendritic or fibrous nanomaterials. In another exemplary embodiment, this would include, a bed, block, cylinder or other geometric form of a porous nanomaterial, such as a form that may be formed from a xerogel or aerogel that includes an inorganic oxide nanomaterial, such as a xerogel or aerogel of silica, alumina or a silica-alumina compound that includes an inorganic oxide nanomaterial.

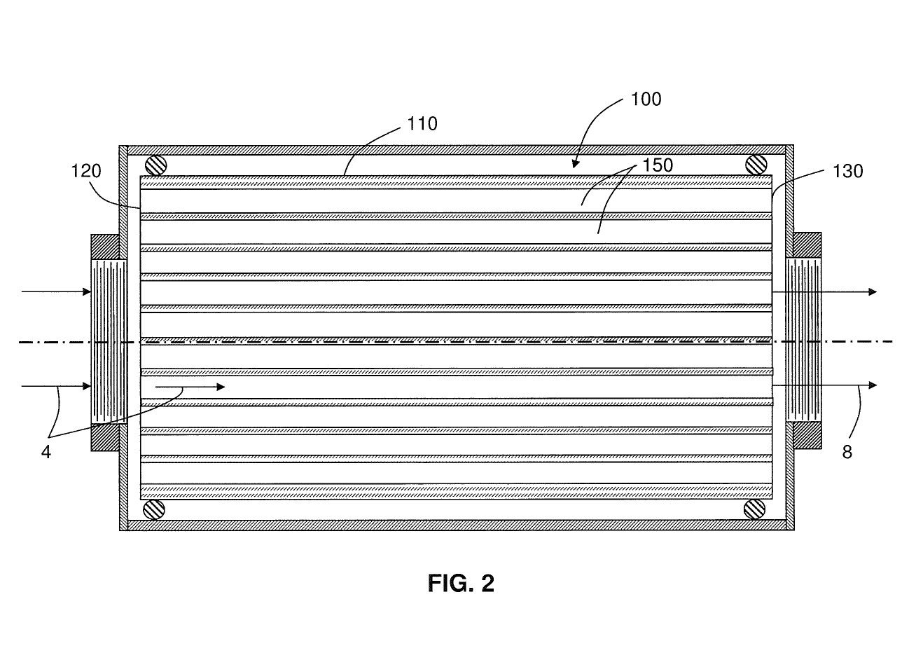

The inorganic oxide nanomaterial may also be used as a filter medium 100 by incorporating this material into a high surface area filter media form 110, such as that illustrated in FIGS. 1 and 2. This high surface area form is a honeycomb-like structure that includes a plurality of flow channels 120 that extend from the inlet end 130 to the outlet end 140. The flow channels 120 are defined by a corresponding plurality of channel walls 150. The channel walls 150 include the inorganic oxide nanomaterial. As may be seen in FIGS. 1 and 2, a given channel wall 150 may be associated with one or more flow channels 120, including providing a divider between them. The flow channels 120 are configured to receive a contaminated liquid fuel 4 that contains a sulfur-containing compound at the inlet end and to communicate and filter contaminated liquid fuel 4 by flow of liquid fuel 4 through flow channel 120 and along channel walls 150 that include the inorganic oxide nanomaterial to the outlet end 140 where the filtered liquid fuel 8 exits the filter medium 100. The inlet end 130 and outlet end 140 are configured for fluid coupling and communication with other portions of a fuel system, such as a fuel inlet line (not shown) and fuel outlet line (not shown), respectively. Alternately, inlet end 130 and outlet end 140 may be in fluid communication with other components of a fuel system, such as various housings or other fuel filter media, such as those designed to filter solid particles or other contaminants, as may be known in the art or otherwise described herein. The flow channels 120 will be configured to provide a high surface area along the channel walls 150, so as to provide a sufficiently large surface area for exposure of the contaminated liquid fuel 4 being communicated through the flow channels 120 with the inorganic oxide nanomaterial included in channel walls 150. Flow channels 120 may have any suitable geometric form and size. In the exemplary embodiment of FIGS. 1 and 2, flow channels 120 have a rectangular cross-sectional shape; however, any suitable geometric shape may be utilized, including a circular cross-sectional shape and various polyhedral cross-sectional shape, such as a hexagonal cross-sectional shape. The cross-sectional area and length of the flow channels 120, as well as the number of flow channels 120, will be selected to provide the desired macroscopic size of the surface over which contaminated liquid fuel 4 flowing through the filter medium may be exposed. The microscopic surface area available for exposure of the contaminated liquid fuel 4, including the sulfur-containing compounds therein, will of course depend upon the characteristics of the inorganic oxide nanomaterial. This will include the morphology of the inorganic oxide nanomaterial (i.e., whether it is particulate, dendritic, fibrous, or porous, or the like, or a combination thereof) and the manner in which the inorganic oxide nanomaterial is included in the channel wall 150.

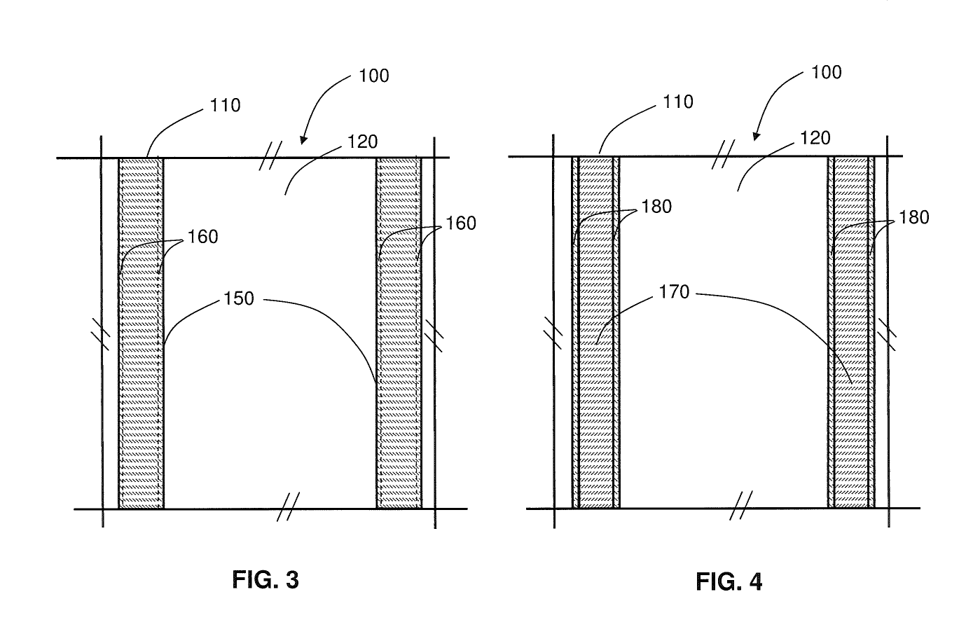

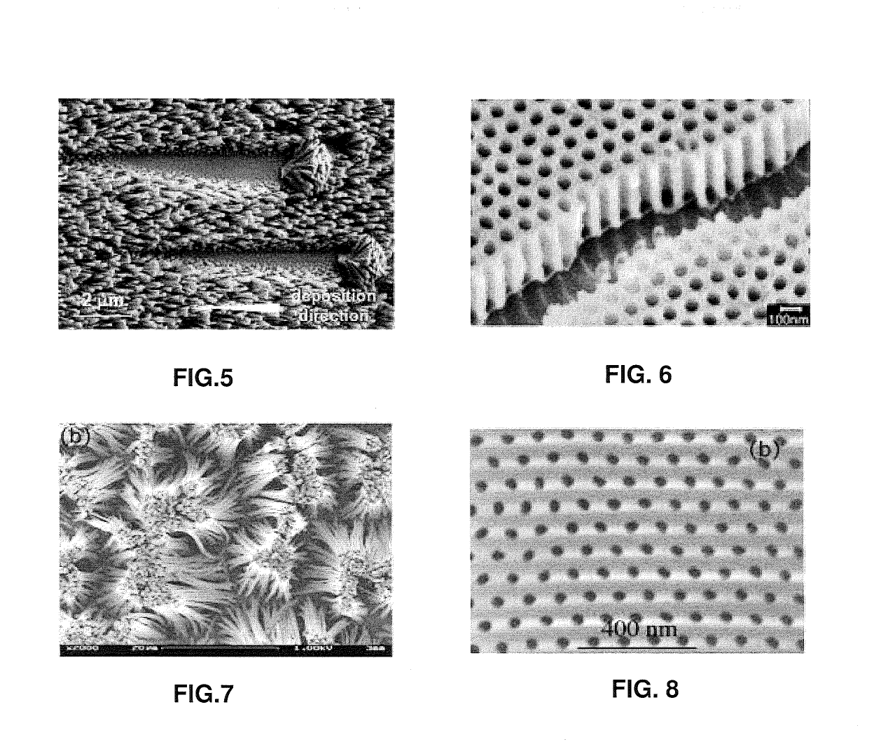

In one exemplary embodiment illustrated in FIG. 3, the channel wall 150 may incorporate the inorganic oxide nanomaterial through the entire thickness of the channel wall 150, and the inorganic oxide nanomaterial includes one or more of the morphological structures described herein. In this configuration, depending on the morphological characteristics of the channel wall 150 and the inorganic oxide nanomaterial included therein, the channel wall 150 may have limited permeability such that the liquid fuel makes contact with the inorganic oxide nanomaterial in the surface region 160 only. In another exemplary embodiment, the channel wall 150 may be porous or sufficiently permeable to enable transport of the liquid fuel through the thickness of channel wall 150, such that liquid fuel is exchanged between adjacent flow channels 150, and exposure to the inorganic oxide nanomaterial and filtering is enabled through the entire thickness of the channel wall 150. Referring to FIG. 4, in another exemplary embodiment, channel wall 150 may comprise a substrate 170 having one or more inorganic oxide nanomaterial layers disposed thereon. The inorganic oxide nanomaterial layer may have any of the morphological forms of the inorganic oxide nanomaterial described herein, including various combinations of these morphological structures. An illustration of a inorganic oxide nanomaterial layer having a dendritic morphology is shown in FIG. 5. An illustration of a porous morphological structure is shown in FIG. 6. Substrate 170 may be any suitable substrate on which an inorganic oxide nanomaterial layer may be disposed. This includes various pure metals and metal alloys, ceramics, glasses, polymers and the like, including composites or other combinations thereof. The substrate 170 may have any form. Exemplary forms include particles, fibers and sheets wherein the inorganic oxide nanomaterial may be disposed on the outer surface of the substrate. Inorganic oxide nanomaterial layer may be disposed on substrate 170 using any suitable process. Examples include conversion of an outer portion of substrate 170 to form inorganic oxide nanomaterial layer by various chemical processes. Alternately, inorganic oxide nanomaterial may be formed by deposition of the inorganic oxide nanomaterial layer onto substrate 170. Examples include, various chemical or physical vapor deposition methods, including those which also employ chemical conversion of a chemically or physically deposited material on the substrate subsequent to its deposition. Further example includes immersion of substrate 170 in a suspension, dispersion or other liquid medium that includes inorganic oxide nanomaterials, such as a slurry of such materials, to deposit a layer of the inorganic oxide nanomaterials, or their precursors, on the surface of substrate 170. This may also include subsequent processing such as various heat treatment processes to bond the inorganic oxide nanomaterial to the substrate 170. The processes used to dispose the inorganic oxide nanomaterial layer on substrate 170 may also include heat treatment, such as calcining, to provide an acidic surface having a pKa of less than or equal to −3, as described herein.

The high surface area form 110 may also incorporate an outer wall 180 to bound the plurality of flow channels 150 as shown in FIG. 1. Alternately, plurality of flow channels 120 may exist as a network of the same having no outer wall 180 (not shown).

Referring again to FIG. 2, the filter medium 100 may be disposed in a housing or column 10 to form a fuel filter 1. Housing 10 includes a fuel inlet first opening 12 through which unfiltered fuel will enter the fuel filter 1 and an outlet or second opening 14 through which the filtered fuel will exit the filter medium 100 and fuel filter 1. Housing 10 may be formed from any suitable material, including various metals or metal alloys, ceramics, glasses or polymers, as well as composites or combinations thereof. In an exemplary embodiment, housing 10 may be formed from a ferrous alloy, such as various grades of steel, stainless steels and the like.

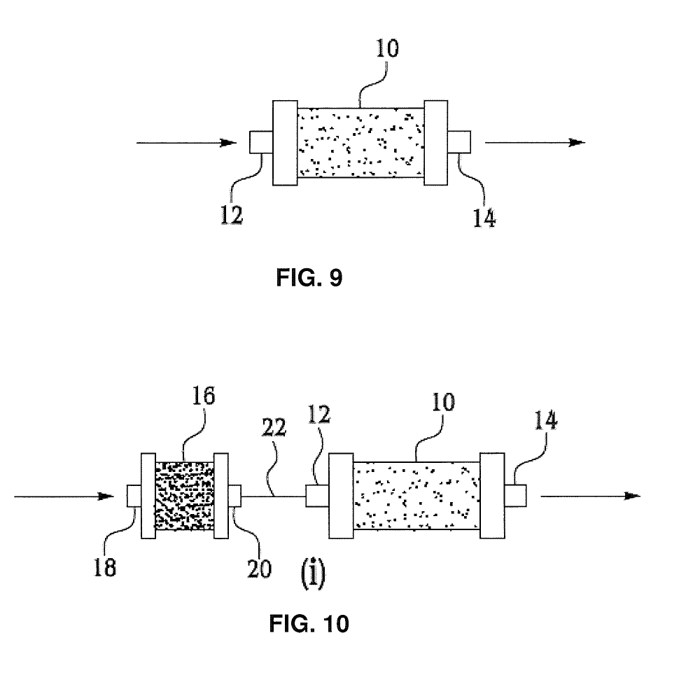

In one exemplary embodiment, the fuel filter and associated filter medium will comprise at least one column comprising the disclosed adsorbents. As illustrated in FIG. 9, at least one column 10 will have a first opening 12 through which unfiltered fuel will enter the column 10 and a second opening 14 through which filtered fuel will exit the column 10. During the normal operation of the fuel filter, the concentration of a sulfur-containing compound in the ‘clean’ fuel exiting the opening 14 will be less than the concentration of the sulfur-containing compound in the “contaminated” fuel entering the opening 12.

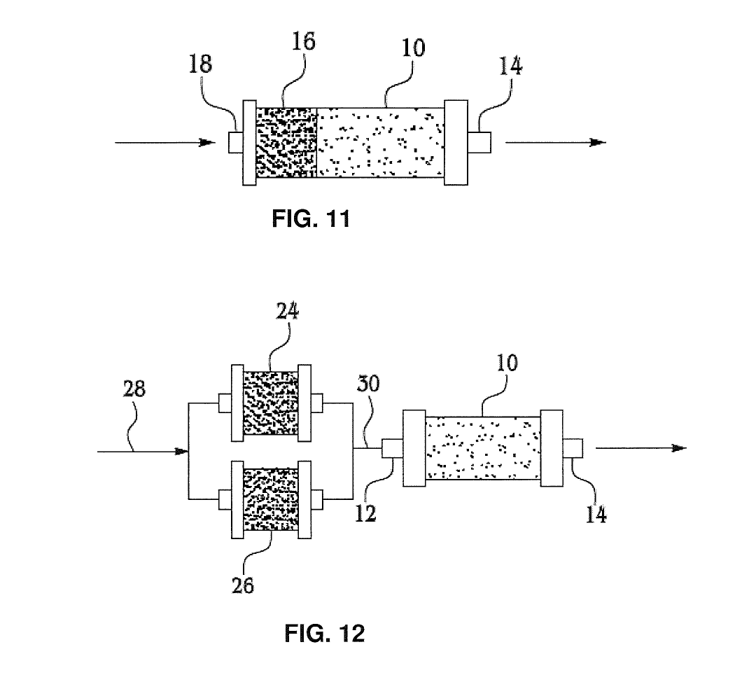

In another exemplary embodiment, the disclosed fuel filter will further comprise at least one guard bed 16 as illustrated in either FIG. 10 or FIG. 11.

As illustrated in FIG. 10, the at least one guard bed 16 may have a first opening 18 through which fuel enters the guard bed, and a second opening 20 though which fuel exits the guard bed. In this embodiment, the guard bed 16 will connected to the at least one column 10 via a hollow conduit 22 through which fuel may pass and be transferred.

Alternatively, in another embodiment as illustrated in FIG. 11, the at least one guard bed 16 may be contiguously attached to column 10 such that fuel enters through a first opening 16, passes through both the guard bed 16 and the column 10, and subsequently exits through the second opening 14 of column 10.

In another embodiment illustrated in FIG. 12, the disclosed fuel filter may comprise at least one column 10 that is linked to two guard beds 24 and 26 via conduits 28 and 30. In this embodiment, the incoming fuel may enter one or both of the guard beds 24 and 26. After exiting from one or both of guard beds 24 and 26, the fuel will be transferred to column 10 via conduit 30. In this embodiment, the fuel entering the column 10 will pass through first opening 12 and exit column 10 via second opening 14.

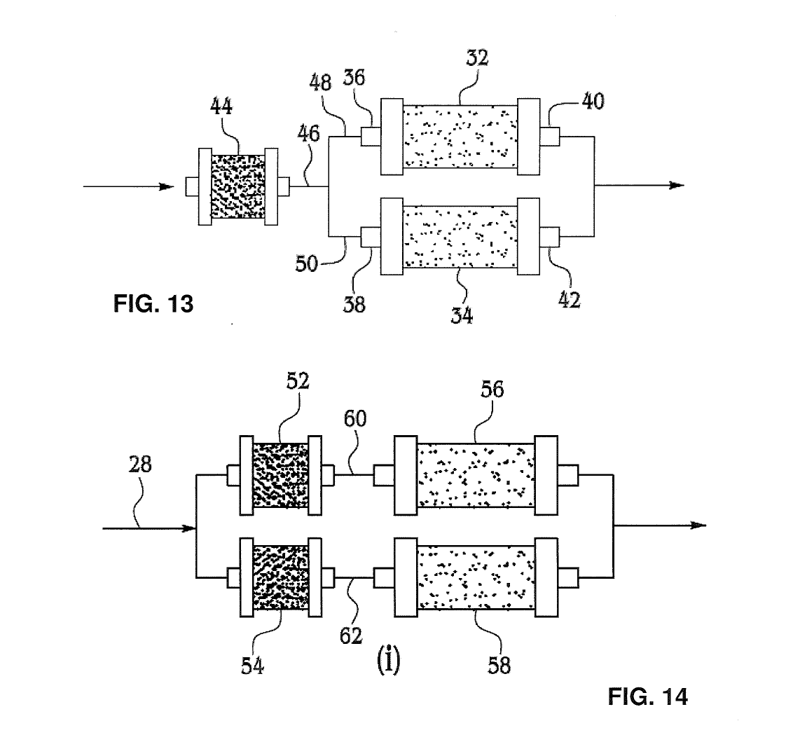

In another embodiment illustrated in FIG. 13, the fuel filter may comprise multiple or dual columns 32 and 34 and a multiple or single guard bed 44. Dual columns 32 and 34 respectively have first openings 36 and 38 through which fuel may enter, and second openings 40 and 42 through which fuel may exit. Single guard bed 44 is connected to dual columns 32 and 34 via conduit 46. Conduit 46 in one embodiment will have conduits 48 and 50 arrayed such that fuel may enter one or both of columns 32 and 34, either sequentially or simultaneously.

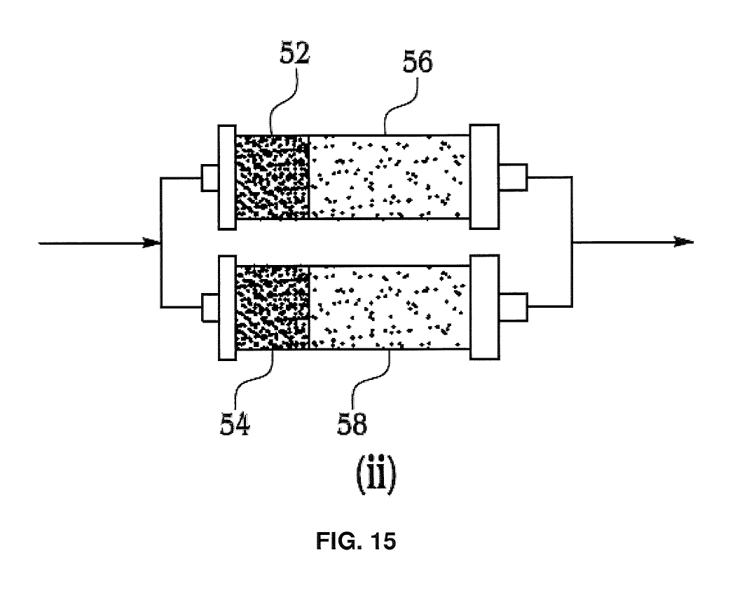

Finally, as illustrated in FIGS. 14 and 15, the disclosed fuel filter may comprise two guard beds 52 and 54 and two columns 56 and 58. As discussed above with regard to the embodiment of FIG. 10, the guard beds 52 and 54 may be respectively connected to columns 56 and 58 via conduits 60 and 62. Alternatively, the guard beds 52 and 54 may be directly attached to columns 56 and 58 without the use of any hollow conduits. As discussed above with regard to FIGS. 12 and 13, the fuel may enter one or both of the guard beds 52 and 54 as well as one or both of columns 56 and 58.

In addition to the disclosed fuel filter, the invention also provides a method for removing a sulfur-containing compound from a post-refinery fuel stream. The disclosed method comprises removing a sulfur-containing compound from a fuel by passing the fuel through the disclosed fuel filters capable of removing a sulfur-containing compound.

In another embodiment, the disclosed methods and processes may further comprise storing the removed sulfur-containing compound, releasing a portion of the stored sulfur-containing compound, and sending the portion to an emission control device.

A sulfur-containing compound is removed from a fuel stream as the fuel is passed through the disclosed fuel filters. In one exemplary embodiment, the sulfur-containing compound is removed as the fuel is passed through at least one column comprising the disclosed adsorbents as discussed above.

In one embodiment, the sulfur-containing compound removed from a fuel stream by the disclosed fuel filter will be stored by the fuel filter. In one exemplary embodiment, the removed sulfur-containing compound will be stored in the at least one column comprising the disclosed adsorbent. In one especially exemplary embodiment, the removed sulfur-containing compound will be stored in the disclosed adsorbent.

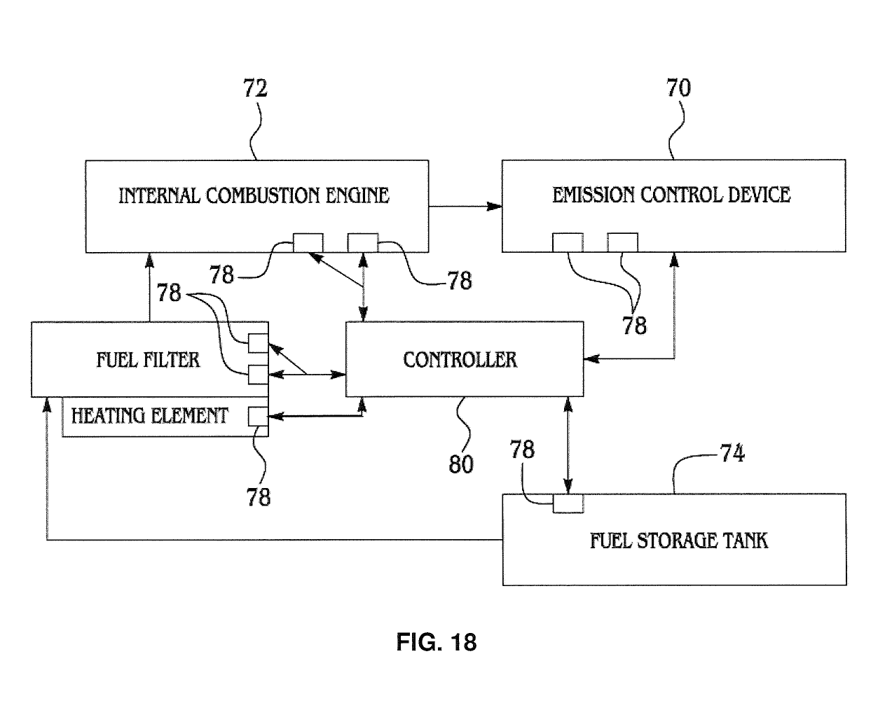

It will be appreciated that over the life of an internal combustion engine the disclosed fuel filter will remove a quantity of sulfur-containing compounds. In one embodiment, at some point, the adsorbent may become incapable of storing any additional sulfur-containing compound even though additional storage is desired. At such a point, the disclosed fuel filter may be regenerated. Non-limiting examples of determining when the fuel filter has become saturated with sulfur-containing compounds are: measuring via sensors the sulfur content of the fuel before and after the fuel filter wherein sulfur measurement equal to or close to those of measurement entering the filter will indicate that the filter is no longer removing sulfur from the fuel; providing sensors to determine how much sulfur the engine is putting out in the exhaust stream; providing sensors in the fuel storage tank to determine the base line in parts per million of the sulfur in the fuel of the vehicle; and providing pressure sensors before and after the fuel filter, wherein any of the aforementioned methods are facilitated through the microprocessor or controller and various sensors communicating therewith as illustrated in FIG. 18. Regeneration of the fuel filter as used herein refers to the release of at least a portion of the stored sulfur-containing compound, i.e., desulfation. Such release or regeneration may be accomplished by one or more methods.

In one exemplary embodiment, the regeneration of the fuel filter may be accomplished by heating the fuel filter to an elevated temperature. In one embodiment, at least one column of the fuel filter will be heated by a heating element (illustrated in FIG. 18) wherein either the adsorbent member of the fuel filter, the fuel or both are heated to a temperature that is greater than the highest normal operating temperature of the fuel stream, wherein the captured sulfur-containing compounds will be released into the fuel stream. In one exemplary embodiment, the heating element is a resistive type-heating element wherein an applied current or voltage from a power supply is used to increase the temperature of the fuel or the adsorbent material in order to release the captured sulfur-containing compounds. Of course, other equivalent heating devices are contemplated for use in exemplary embodiments of the present invention. In one exemplary embodiment, at least one column of the fuel filter will be heated to a temperature that is equal to or greater than about 100° C. In another embodiment, the at least one column of the fuel filter will be heated to a temperature that is equal to or below the boiling point of the fuel.

In another embodiment, the fuel filter may be regenerated by the use of a heated fuel stream or by displacement by a solvent other than the fuel, wherein the solvent is released from a solvent reservoir in fluid communication with the fuel stream and is capable of releasing the captured sulfur-containing compounds from the adsorbent member. In one exemplary embodiment the solvent is released from the reservoir and then recaptured by a suitable filter or alternatively the solvent is a material capable of being consumed by the internal combustion engine without damaging the same or the associated emission control devices.

The portion of the stored sulfur-containing compound released by the regeneration of the fuel filter is sent through an internal combustion engine and into an emission control device, especially a post-combustion emission control device. Emission control device as used herein refers to nitrogen oxide or ‘NOx’ adsorbers used to remove nitrogen oxides from the exhaust streams of both mobile and stationary internal combustion engines. In one embodiment, the emission control device will be a Lean NOx Trap or LNT. ‘Post-combustion’ refers to a device positioned to receive the products of combustion from an internal combustion engine, i.e., located downstream from the internal combustion engine.

In one exemplary embodiment, the released portion will be sent through the engine and into the emission control device so that it enters the emission control device at a time or operation in the device's operational cycle when the effect of the increased concentration of sulfur is minimized.

In another embodiment, the portion may be sent through the engine and into a post combustion emission device such as a NOx adsorber at a time during its cycle that is less sensitive to high sulfur levels. In a more preferred embodiment, the portion of sulfur-containing compound released by the regeneration of the disclosed fuel filter will be sent to a NOx adsorber at a time when the NOx adsorber and/or NOx adsorber catalyst is undergoing a regenerative process either for NOx or desulfation.

The catalysts in NOx adsorbers typically undergo regenerative processes designed to increase the efficiency of the catalyst/NOx adsorber. A first type of regenerative process is designed to convert the nitrogen oxides to nitrogen. In a second type of regenerative process, contaminants such as sulfur-containing compounds are driven off. The later process is sometimes referred to as desulfation and typically occurs at higher temperatures.

In one exemplary embodiment, the portion of the sulfur-containing compound released by the regeneration of the disclosed fuel filter will be sent to a NOx adsorber at a time when the NOx adsorber and/or NOx adsorber catalyst is undergoing a regenerative process that results in the removal or release of nitrous oxides via reduction.

In another embodiment, the portion of the sulfur-containing compound released by the regeneration of the disclosed fuel filter will be sent to a NOx adsorber at a time when the NOx adsorber and/or NOx adsorber catalyst is undergoing a regenerative process that results in the liberation of the sulfur-containing compounds, i.e., desulfation.

In one exemplary embodiment the release of the portion and its sending to an emission control device will occur over a short period of time relative to the regeneration period of the fuel filter. In one exemplary embodiment, the regeneration period of the fuel filter approximates the regeneration period of the emission control device. In accordance with exemplary embodiments of the present invention, the regeneration period of the emission control device will be maximized as the fuel filter will reduce the amount of sulfur being deposited on the NOx adsorber thus, regeneration periods can be less frequent and at longer intervals.

Also disclosed herein is a method and apparatus for extending the life cycle of an emission control device 70 in fluid communication with the exhaust of an internal combustion engine 72. This apparatus or system includes the disclosed fuel filter for removing and storing sulfur-containing compounds from a post-refinery fuel stream is illustrated schematically in FIG. 18. As illustrated, the internal combustion engine receives fuel from a fuel storage tank 74 via the fuel filter. A non-limiting example of an apparatus, method or means for monitoring and controlling the release of stored sulfur-containing compounds into the fuel stream is illustrated in FIG. 18.

In one embodiment, the emission control device is a post combustion emission control device that receives the gaseous products of combustion from the combustion chamber of the internal combustion engine.

In one exemplary embodiment, the apparatus, method or means for monitoring and controlling the release of stored sulfur-containing compounds is an on-board control apparatus comprising a plurality of sensors 78 each providing signals to a microprocessor or controller 80 comprising programmable logic that is configured to receive signals from the plurality of sensors and provide signals to the fuel filter and its associated heater element, the internal combustion engine, fuel delivery and ignition systems to vary the air to fuel flow mixture, if necessary (e.g., lean or rich operation to increase exhaust temperature) and heater elements of the emission control device wherein and upon receipt of the appropriate signals (e.g., fuel filter sulfur capacity reached and emission control device operating in or at a desulfurization or regeneration mode) the microprocessor will instruct the release of the sulfur into the fuel stream wherein the same can be received by the emission control device without adversely affecting the same.

It is understood that a controller operating in response to a computer program may implement the processing of the above description. In order to perform the prescribed functions and desired processing, as well as the computations therefore, the controller may include, but not be limited to, a processor(s), computer(s), memory, storage, register(s), timing, interrupt(s), communication interfaces, and input/output signal interfaces, as well as combinations comprising at least one of the foregoing.

As described above, algorithms for implementing exemplary embodiments of the present invention can be embodied in the form of computer-implemented processes and apparatuses for practicing those processes. The algorithms can also be embodied in the form of computer program code containing instructions embodied in tangible media, such as floppy diskettes, CD-ROMs, hard drives, or any other computer-readable storage medium, wherein, when the computer program code is loaded into and executed by a computer and/or controller, the computer becomes an apparatus for practicing the invention. Existing systems having reprogrammable storage (e.g., flash memory) that can be updated to implement various aspects of command code, the algorithms can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer. When implemented on a general-purpose microprocessor, the computer program code segments configure the microprocessor to create specific logic circuits.

These instructions may reside, for example, in RAM of the computer or controller. Alternatively, the instructions may be contained on a data storage device with a computer readable medium, such as a computer diskette. Or, the instructions may be stored on a magnetic tape, conventional hard disk drive, electronic read-only memory, optical storage device, or other appropriate data storage device. In an illustrative embodiment of the invention, the computer-executable instructions may be lines of compiled C++ compatible code.

In an exemplary embodiment the controller includes logic for evaluating signals from the plurality of sensors to determine if the sulfur from the fuel filter is to be released into the fuel stream during a desulfurization or regeneration process of the emission control device. In one non-limiting embodiment, a means for controlling the release of the sulfur will comprise a circuit and sensor for identifying a predetermined temperature or pressure in either the engine or the emission control device that signals the appropriate time for release.

The filter media is further described by the following non-limiting examples.

### EXAMPLES

### Example 1

In this example a correlation between surface acidity and sulfur removal was explored.

A visual color change method was used to assess the surface acidity of a number of inorganic oxides, including those with high as well as low sulfur capacity. The following materials were tested:

Alumina 1 which had been heated at 450° C. under flowing nitrogen.

Alumina 1 which had been heated at 160° C. under flowing nitrogen.

Alcoa Selexsorb CDX heated at 450° C. under flowing nitrogen under flowing nitrogen.

Gamma Alumina (Brockmann's) heated at 450° C. under flowing nitrogen.

Merck Silica, 40 angstrom (Å) heated at 160° C. under flowing nitrogen.

Y—H+ Zeolite heated at 450C in air.

Alumina 1 used as received.

The materials treated as above were then exposed to a series of indicator dyes that turn color at specific acid strengths (pKa values):

| | |
|---|---|
| 9,10-Anthraquinone- | pKa = −8.2 Most Acid Color Change |
| Dicinnamalacetone- | pKa = −3.0 |
| Methyl Yellow- | pKa = +3.3 |
| Methyl Red- | pKa = +4.8 |

The most acidic dye indicator (9,10-Anthraquinone) turns from colorless to a bright yellow if the acid strength is at least about that of sulfuric acid.

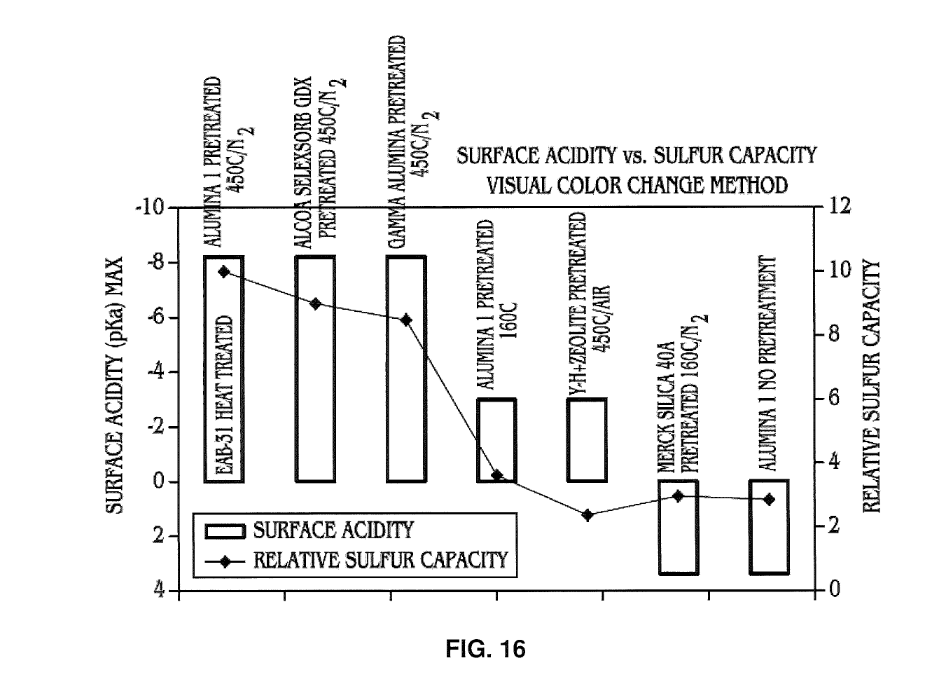

The results and the correlation to sulfur removal capacity are set forth in FIG. 16. The semi-quantitative surface acidity values are charted on the left Y-axis, and the bar height corresponds to surface acidity as measured using the dye indicators. The values plotted represent the minimum acidity, since no dye indicators were available to assess acidity more strong than a pKa of −8.2. The right Y-axis (blue line) indicates the relative sulfur capacity as determined using the stirred reactor sulfur uptake protocol employed in Example 2 below. These data show a good correlation between surface acidity and sulfur capacity, with the exception of the Y—H+ zeolite. The surface acidity of this material might indicate a higher sulfur capacity than actually measured, and it is thought that the relatively small pore size of the zeolite (˜8 Å) might hinder uptake of the bulky dimethyl dibenzothiophene-class of compounds.

### Example 2

In this example a correlation between surface acidity of η-Alumina and sulfur removal from ultra low sulfur diesel (ULSD) was explored.

Three grams of η-alumina were calcined overnight at 450° C. in a stream of nitrogen gas flowing at 0.35 Liters/minute (L/min). The calcined alumina was divided among four glass dishes, and each dish was placed in a 1-Liter jar that contained a different desiccant. The desiccants used were magnesium sulfate, calcium chloride, calcium sulfate, and phosphorus pentoxide. The calcined alumina was allowed to equilibrate at the four hydration levels for 24 hours.

The surface acidity of the η-alumina was determined using the procedure found in Benesi, H. A., J. Am. Chem. Soc., 1956, 78, 5490-5494. The indicators used in this work were methyl red, methyl yellow, crystal violet, dicinnamalacetone, and anthraquinone. Solutions of the colorimteric indicators were prepared by dissolving 3 milligrams (mg) of the indicator in 15 milliliters (mL) of cyclohexane. In some cases the solid indicator did not completely dissolve in the cyclohexane. The calcined alumina in the different humidity levels was tested for its surface acidity by adding 0.2 grams of hydrated alumina to 2 mL of the indicator solution. The color change was noted and correlated with the pKa of the indicator.

The extent of sulfur removal of the alumina at each hydration level was measured using a static uptake procedure. The alumina (0.15 g) was added to a vial containing 15 mL of ultra-low sulfur diesel fuel (ULSD). The mixture was stirred for 19 hours while it was heated to 60° C. After 19 hours, the stirring was stopped and the solids settled to the bottom of the vial. A portion of the diesel fuel was removed and analyzed for sulfur using an Antek Model 9000VLLS analyzer.

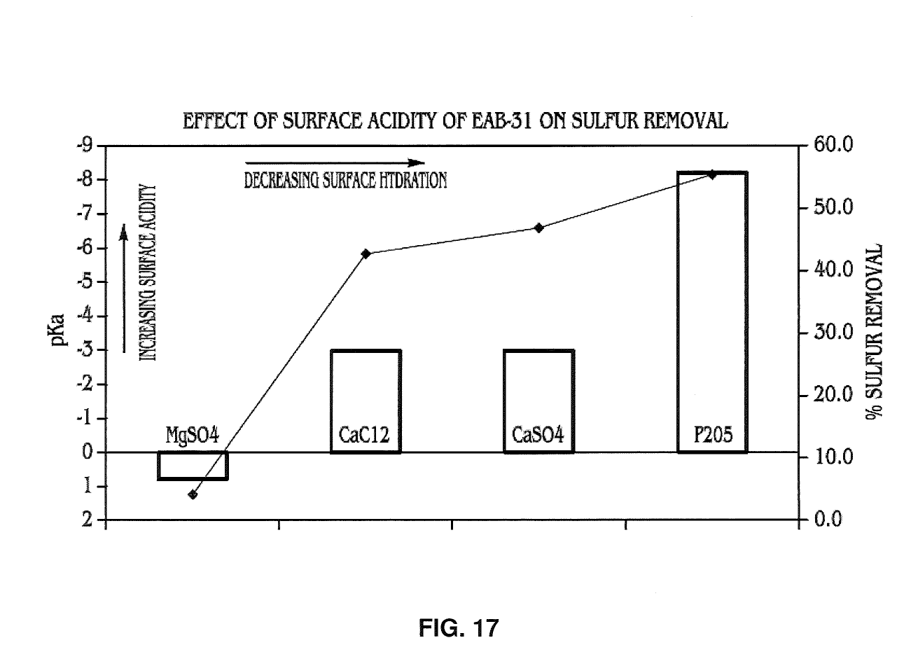

The surface acidity of the η-alumina at the various hydration levels is correlated with the sulfur removal of the η-alumina in FIG. 17. It can be seen that increasing the surface acidity of the inorganic oxide increases the ability of the adsorbent to remove sulfur-containing compounds from a fuel.

It will be appreciated throughout this discussion that the singular forms “a”, “an” and “the” include plural referents unless the context clearly dictates otherwise. Similarly, throughout “optional” or “optionally” means that the subsequently described event or circumstance may or may not occur, and that the description includes instances where the event occurs and instances where it does not. Likewise, the modifier “about” used in connection with a quantity is inclusive of the stated value and has the meaning dictated by the context (e.g., includes the degree of error associated with measurement of the particular quantity).

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A filter medium for removing a sulfur-containing compound from a liquid fuel, comprising an inorganic oxide nanomaterial having a surface acidity characterized by a pKₐ value of less than or equal to −3.

2. The filter medium of claim 1, wherein the nanomaterial is particulate, dendritic, fibrous, porous, or a combination thereof.

3. The filter medium of claim 1, wherein the nanomaterial has pores having an average diameter of 1 to 40 angstroms.

4. The filter medium of claim 1, wherein the surface area of the inorganic oxide nanomaterial is about 50 to about 5000 squared meters per gram.

5. The filter medium of claim 1, wherein the surface area of the inorganic oxide nanomaterial is about 50 to about 1500 squared meters per gram.

6. The filter medium of claim 1, wherein the surface area of the inorganic oxide nanomaterial is about 150 to about 500 squared meters per gram.

7. The filter medium of claim 3, wherein the inorganic oxide nanomaterial is an aerogel or xerogel of silica, alumina or a silica-alumina compound.

8. The filter medium of claim 1, wherein the inorganic oxide nanomaterial is particulate.

9. The filter medium of claim 8, wherein the particulates have an average size of one or more major dimensions that is less than about 500 nanometers.

10. The filter medium of claim 1, wherein the surface acidity of the inorganic oxide nanomaterial is characterized by a pKₐ value of less than or equal to −6.

11. The filter medium of claim 1, wherein the inorganic oxide nanomaterial comprises alumina, alumina-boria, alumina phosphate, activated alumina, hafnia, kaolinite, magnesia, montmorillonite, aluminosilicates, silica gels, clay, active clay, silica, silica-magnesia, mesoporous silica porous material (FSM), silica-alumina, solid super acids, solid super acids-sulfated, titania, zeolites, zirconia, sulfated zironia, or a combination thereof.

12. The filter medium of claim 1, wherein the inorganic oxide nanomaterial is disposed on a substrate.

13. The filter medium of claim 12, wherein the substrate comprises a metal, ceramic, glass, or polymer, or a combination thereof.

14. The filter medium of claim 12, wherein the substrate comprising a plurality of particles, each having an outer surface, and the inorganic oxide nanomaterial is disposed on the outer surfaces of the particles.

15. A method of filtering a liquid fuel comprises contacting a liquid fuel with a filter medium comprising an inorganic oxide nanomaterial having a surface acidity characterized by a pKₐ value of less than or equal to −3.

16. The method of claim 15, wherein the liquid fuel comprises a post-refinery liquid fuel.

17. The method of claim 15, wherein the liquid fuel is selected from gasoline, diesel fuel, liquefied petroleum gas, kerosene, and a combination thereof.

18. The method of claim 15, wherein contacting removes a sulfur-containing compound selected from the group consisting of a sulfide, a thiophene, a mercaptan, and a combination thereof.
